(19) United States
(12) Patent Application Publication
(10) Pub. No.: US 2020/0324571 A1
(43) Pub. Date: Oct. 15, 2020

(54) NON-PNEUMATIC TIRES WITH BRAKE COOLING SPOKES

(71) Applicant: Ford Global Technologies, LLC, Dearborn, MI (US)

(72) Inventors: Janice Lisa Tardiff, Plymouth, MI (US); Adam Wirth, Belleville, MI (US); Cindy Sofia Barrera-Martinez, Dearborn, MI (US); Wesley Grant Morris, Dearborn, MI (US); Matthew Aaron Knych, Dearborn, MI (US)

(73) Assignee: Ford Global Technologies, LLC, Dearborn, MI (US)

(21) Appl. No.: 16/838,262

(22) Filed: Apr. 2, 2020

Related U.S. Application Data
(60) Provisional application No. 62/832,926, filed on Apr. 12, 2019.

(51) Int. Cl. B60B 1/02; B60B 27/00

(52) U.S. Cl. CPC B60B 1/0246; B60B 27/0047

(57) ABSTRACT

A non-pneumatic tire includes a wheel hub portion, a tread ring portion, and a plurality of flexible spokes extending between and coupled to the wheel hub portion and the tread ring portion. A hollow core is positioned between adjacent flexible spokes or formed within each flexible spoke. The plurality of flexible spokes are configured to cyclically move between a narrow position to a wide position when the non-pneumatic tire is attached to a vehicle and is rolling on a road surface such that the plurality of flexible spokes act as a bellows that pumps air from one side of the non-pneumatic tire to another side of the non-pneumatic tire.

### CROSS-REFERENCE TO RELATED APPLICATIONS

This application claims priority to U.S. provisional application No. 62/832,926 filed on Apr. 12, 2019. The disclosure of the above application is incorporated herein by reference.

### FIELD

The present disclosure relates to non-pneumatic tires, and more particularly to the design aspects and performance features of non-pneumatic tires.

### BACKGROUND

The statements in this section merely provide background information related to the present disclosure and may not constitute prior art.

Non-pneumatic tires typically have spokes that undergo cyclic compression as the tires roll over surfaces (e.g., a road surface) and during braking events. Particularly, as a non-pneumatic tire rolls over a road surface, spokes of the tire proximate or attached to a section of the tire that is in contact with the road surface undergo compression. After the section of the tire rolls past and is no longer in contact with the road surface, the spokes return to their original state. This compression is accentuated during braking events.

Brakes attached to the wheel or tire (e.g., a non-pneumatic tire) reduce the speed of a vehicle using friction between brake shoes and a brake drum or friction between brake pads and a brake rotor. The friction results in heating of the brakes which may reduce their performance when the thermal capacity of the braking system is exceeded. A common challenge with any braking system is the ability to dissipate the heat generated from friction (i.e., heat resulting from the conversion of kinetic energy) in an adequate manner to enhance the braking capability and wear life. Mass flow of the incoming and outgoing air around a brake system is the primary dissipation method for the heat generated by brakes.

The present disclosure addresses the issues of heating of vehicle brakes beyond their capacity, as well as heat dissipation of vehicle brakes, among other issues related to brakes for vehicles.

### SUMMARY

Further areas of applicability will become apparent from the description provided herein. It should be understood that the description and specific examples are intended for purposes of illustration only and are not intended to limit the scope of the present disclosure.

In one form of the present disclosure, a non-pneumatic tire includes a wheel hub portion, a tread ring portion, a plurality of flexible spokes extending between and coupled to the wheel hub portion and the tread ring portion, and a plurality of hollow cores defined between adjacent flexible spokes or within the plurality of flexible spokes. The plurality of flexible spokes are configured to cyclically move between a narrow position and a wide position such that air is pumped from one side of the non-pneumatic tire to another side of the non-pneumatic tire when the non-pneumatic tire is attached to a vehicle and is rolling on a road surface.

In some variations of the present disclosure, the plurality of hollow cores is a plurality of diamond-shaped hollow cores. And in at least one variation the plurality of flexible spokes is a plurality of diamond-shaped flexible spokes.

In some variations a brake rotor is positioned on the inner side of the wheel hub portion. In such variations each of the plurality of diamond-shaped flexible spokes can be configured as a bellows to force air from an outer side of the wheel hub portion to an inner side of the wheel hub portion such that air is pumped towards the brake rotor. In the alternative, the plurality of diamond-shaped flexible spokes can be configured as a bellows to force air from an inner side of the wheel hub portion to an outer side of the wheel hub portion such that air is pumped away from the brake rotor.

In at least one variation, each of the plurality of diamond-shaped flexible spokes includes a pair of inner legs and a pair of outer legs, and each of the plurality of hollow cores is defined by a pair of inner legs and a pair of outer legs. In such variations, each of the plurality of diamond-shaped flexible spokes comprises a pair of corners with one of the pair of inner legs intersecting one of the pair of outer legs at one of the pair of corners and another of the pair of inner legs intersecting another of the pair of outer legs at another of the pair of corners. In some variations a distance between the pair of corners of each of the plurality of diamond-shaped flexible spokes increases from an outer side of the wheel hub portion to an inner side of the wheel hub portion. IN other variations a distance between the pair of corners of each of the plurality of diamond-shaped flexible spokes decreases from an outer side of the wheel hub portion to an inner side of the wheel hub portion.

In another form of the present disclosure, a vehicle wheel assembly includes a non-pneumatic tire, a brake rotor and a brake caliper. The non-pneumatic tire includes a wheel hub portion, a tread ring portion, a plurality of flexible spokes extending between and coupled to the wheel hub portion and the tread ring portion, and a plurality of hollow cores defined between adjacent flexible spokes or within the plurality of flexible spokes. The plurality of flexible spokes are configured to cyclically move between a narrow position and a wide position such that air is pumped from one side of the non-pneumatic tire to another side of the non-pneumatic tire when the vehicle wheel assembly is attached to a vehicle and is rolling on a road surface.

In some variations each of the plurality of flexible spokes is configured as a bellows to force air from an outer side of the wheel hub portion to an inner side of the wheel hub portion. In other variations each of the plurality of flexible spokes is configured as a bellows to force air from an inner side of the wheel hub portion to an outer side of the wheel hub portion. In at least one variation a cross-sectional area of each of the plurality of hollow cores increases from an outer side of the wheel hub portion to an inner side of the wheel hub portion. And in at least one other variation of the present disclosure, a cross-sectional area of each of the plurality of hollow cores decreases from an outer side of the wheel hub portion to an inner side of the wheel hub portion.

In still another form of the present disclosure, a method of cooling a vehicle brake includes rolling a vehicle wheel assembly along a road surface. The vehicle wheel assembly includes a non-pneumatic tire and a brake, and the non-pneumatic tire has a wheel hub portion, a tread ring portion, a plurality of flexible spokes extending between and coupled to the wheel hub portion and the tread ring portion, and a plurality of hollow cores defined between adjacent flexible spokes or within the plurality of flexible spokes. In at least one variation a cross-sectional area of each of the plurality of hollow cores increases or decreases from an outer side of the wheel hub portion to an inner side of the wheel hub portion. The method also includes cooling the brake by cyclically compressing and de-compressing the plurality of flexible spokes as the vehicle wheel assembly rolls along the road surface such that air is pumped from one side of the wheel hub portion to another side of the wheel hub portion.

In some variations cyclically compressing and de-compressing the plurality of flexible spokes pumps air from an outer side of the wheel hub portion to an inner side of the wheel hub portion such that the brake rotor is cooled. In other variations cyclically compressing and de-compressing the plurality of flexible spokes pumps air from an inner side of the wheel hub portion to an outer side of the wheel hub portion such that the brake rotor is cooled.

### DRAWINGS

In order that the disclosure may be well understood, there will now be described various forms thereof, given by way of example, reference being made to the accompanying drawings, in which:

FIG. 1A is a side view of a non-pneumatic tire according to the teachings of the present disclosure;

FIG. 1B is a front view of the non-pneumatic tire in FIG. 1A;

FIG. 2A is an enlarged view of circled region 2A in FIG. 1A according to the teachings of the present disclosure;

FIG. 2B is an enlarged view of circled region 2B in FIG. 1A according to the teachings of the present disclosure;

FIG. 3A is a cross-sectional view of section A-A from FIG. 2A according to the teachings of the present disclosure;

FIG. 3B is a cross-sectional view of section B-B from FIG. 2B according to the teachings of the present disclosure;

FIG. 4A is a cross-section view of section C-C in FIG. 2A according to the teachings of the present disclosure; and

FIG. 4B is a cross-section view of section D-D in FIG. 2B according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

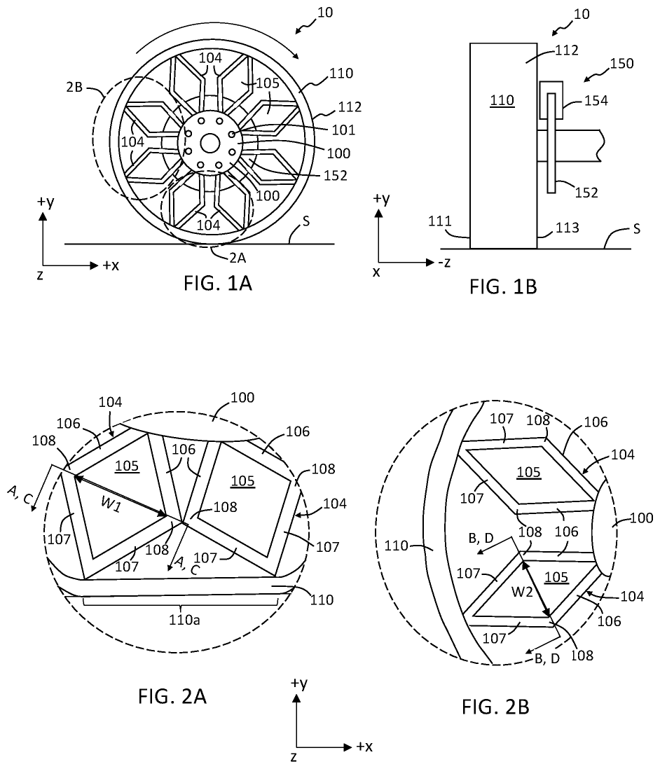

Referring now to FIGS. 1A and 1B, a side view and a front view, respectively, of a non-pneumatic tire 10 rolling on a road surface ‘S’ according to the teachings of the present disclosure are schematically depicted. The non-pneumatic tire 10 includes a wheel hub portion 100 with an outer side 111 and an inner side 113, a tread ring portion 110, and a plurality of spokes 104 extending between and attached to the wheel hub portion 100 and the tread ring portion 110. In some aspects of the present disclosure, the plurality of spokes 104 are arranged such that a hollow core 105 is defined between and/or positioned within a pair of adjacent spokes 104. In some aspects of the present disclosure, the hollow core 105 is a diamond-shaped hollow core. The wheel hub portion 100 includes a plurality of lug nut apertures 101 and the tread ring portion includes a tread 112. During use of the non-pneumatic tire 10, a brake 150 (FIG. 1B) is positioned proximate to the inner side 113 of the non-pneumatic tire 10. Non-limiting examples of brake components of the brake 150 include a brake drum, a brake rotor, among others. In some aspects of the present disclosure, the brake 150 includes a brake rotor 152 and a caliper 154 as schematically depicted in FIG. 1B.

Referring now to FIG. 2A, an enlarged view of circled region 2A in FIG. 1A schematically depicting two spokes 104 in a compressed state is shown. Each of the spokes 104 comprise an inner leg 106 and an outer leg 107. The inner leg 106 is attached to and extends from the wheel hub portion 100 to the outer leg 107 and the outer leg 107 is attached to and extends from the tread ring portion 110 to the inner leg 106. The inner leg 106 and the outer leg 107 intersect at a corner or elbow 108. As shown in FIG. 2A, a section 110a of the tread ring portion 110 in contact with the road surface S is generally compressed (also referred to herein as the “contact patch 110a”). For example, as the non-pneumatic tire 10 rolls over a road surface, weight of a vehicle (not shown) to which the non-pneumatic tire 10 is attached results in compression of the tread ring portion 110 and the spokes 104 positioned proximate to the contact patch 110a. The compression of the spokes 104 results in the inner legs 106 and outer legs 107 forming the hollow core 105 to be displaced away from each other. Displacement of the inner legs 106 and outer legs 107 in a direction away from each other provides a distance W1 between the corners 108 at the outer side 111 (FIG. 1B) of the non-pneumatic tire 10.

Referring now to FIG. 2B, as the non-pneumatic tire 10 continues to roll over the road surface S, the spokes 104 shown in FIG. 2A de-compress such that the inner legs 106 and outer legs 107 forming the hollow core 105 are displaced towards each other. Displacement of the inner legs 106 and outer legs 107 in a direction towards each other provides a distance W2 less than distance W1 between the corners 108 at the outer side 111 of the non-pneumatic tire 10 (FIG. 1B).

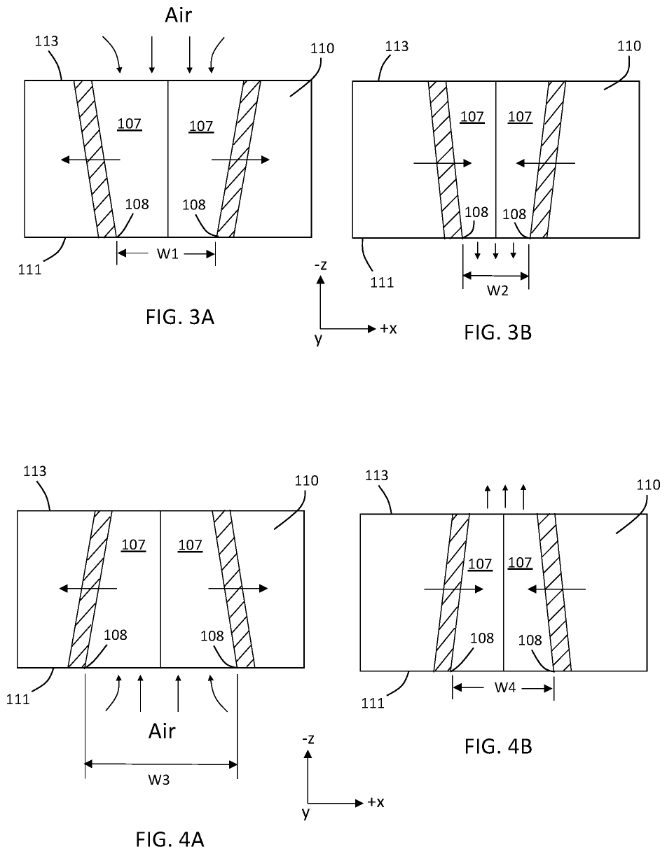

Referring now to FIGS. 3A and 3B, sectional views of section A-A in FIG. 2A and section B-B in FIG. 2B, respectively, are shown according to one variation of the present disclosure. Particularly, FIG. 3A depicts the outer legs 107 (and inner legs 106) forming the hollow core 105 being displaced away from each other (i.e., spokes 104 in a “wide” position) and FIG. 3B depicts the outer legs 107 (and inner legs 106) forming the hollow core 105 being displaced towards each other (i.e., spokes 104 in a “narrow” position). The spokes 104 in the wide position (FIG. 3A) have the distance W1 between the corners 108 at the outer side 111 and the spokes 104 in the narrow position (FIG. 3B) have the distance W2 between corners 108 at the outer side 111. Also, the spokes 104, i.e., the inner legs 106, the outer legs 107 and the corners 108, vary in distance between each other across the width (z direction) of the non-pneumatic tire 10. Stated differently, a cross-sectional area of the hollow core 105 on the x-y plane shown in the figures varies along the width (z direction) of the non-pneumatic tire 10. Accordingly, and as shown by the arrows in FIGS. 3A and 3B, the spokes 104 are configured as a bellows that draws air into the hollow core 105 when the spokes 104 move from the narrow position to the wide position (FIG. 3A) and expels air from the hollow core 105 when the spokes 104 move from the wide position to the narrow position (FIG. 3B). Accordingly, in some aspects of the present disclosure, the non-pneumatic tire 10 (i.e., the spokes 104) pump air from the inner side 113 of the non-pneumatic tire 10 to the outer side 111. It should be understood that air proximate to the brake 150, e.g., the brake rotor 152, can be pumped away from the brake 150 such that the brake 150 is cooled. That is, warm air surrounding the brake 150 is replaced by cooler air via pumping the warm air from the inner side 113 of the non-pneumatic tire 10 to the outer side 111.

While FIGS. 3A and 3B schematically depict the corners 108 of the non-pneumatic tire 10 increasing in distance therebetween from the outer side 111 to the inner side 113 (i.e., the cross-sectional area of the hollow cores 105 on the x-y plane increasing from the outer side 111 to the inner side 113), FIGS. 4A and 4B, schematically depict the corners 108 of the non-pneumatic tire 10 decreasing in distance therebetween from the outer side 111 to the inner side 113 according to another variation of the present disclosure. Stated differently, the cross-sectional area of the hollow core 105 on the x-y plane shown in the figures decreases from the outer side 111 to the inner side 113. Particularly, sectional views of section C-C in FIG. 2A and section D-D in FIG. 2B are schematically depicted in FIGS. 4A and 4B, respectively. FIG. 4A depicts the spokes 104 in a wide position and FIG. 4B depicts the spokes 104 in a narrow position. The spokes 104 in the wide position (FIG. 4A) have a distance W3 between the corners 108 at the outer side 111 and the spokes 104 in the narrow position (FIG. 3B) have a distance W4 less than W3 at the outer side 111 between corners 108. However, and as shown by the arrows in FIGS. 4A and 4B, the spokes 104 are configured as a bellows that pump air from the outer side 111 into the hollow core 105 when moving from the narrow position to the wide position (FIG. 4A) and expels air from the hollow core 105 to the inner side 113 when moving from the wide position to the narrow position (FIG. 4B). Accordingly, in some variations of the present disclosure, the non-pneumatic tire 10 (i.e., the spokes 104) pumps air from the outer side 111 of the non-pneumatic tire 10 to the inner side 113. It should be understood that air proximate to the brake 150, e.g., the brake rotor 152, can be displaced with cooler air such that the brake 150 is cooled. That is, warm air surrounding the brake 150 is displaced by cooler air via pumping cooler air from the outer side 111 of the non-pneumatic tire 10 to the inner side 113.

While FIGS. 1A-4B schematically depict the spokes 104 in the form of a diamond, it should be understood that other shaped spokes that pump air from one side of a non-pneumatic tire to another side of the non-pneumatic tire are included within the teachings of the present disclosure. Non-limiting examples of shapes formed by spokes include circular shapes, elliptical shapes, triangular shapes, rectangular shapes, among others. Also, in some variations of the present disclosure, the spokes 104 include additional features that enhance pumping air from one side of the non-pneumatic tire 10 to another side of the non-pneumatic tire 10. Non-limiting examples of such features include flaps positioned at the inner side, flaps positioned at the outer side, flaps positioned between the inner side and the outer side, vanes positioned at the inner side, vanes positioned at the outer side, vanes positioned between the inner side and the outer side, and the like.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A non-pneumatic tire comprising:
a wheel hub portion and a tread ring portion;
a plurality of flexible spokes extending between and coupled to the wheel hub portion and the tread ring portion;
a plurality of hollow cores defined between adjacent flexible spokes or within the plurality of flexible spokes, wherein the plurality of flexible spokes are configured to cyclically move between a narrow position and a wide position such that air is pumped from one side of the non-pneumatic tire to another side of the non-pneumatic tire when the non-pneumatic tire is attached to a vehicle and is rolling on a road surface.

2. The non-pneumatic tire according to claim 1, wherein the plurality of hollow cores is a plurality of diamond-shaped hollow cores.

3. The non-pneumatic tire according to claim 1, wherein the plurality of flexible spokes is a plurality of diamond-shaped flexible spokes.

4. The non-pneumatic tire according to claim 3, wherein each of the plurality of diamond-shaped flexible spokes is configured as a bellows to force air from an outer side of the wheel hub portion to an inner side of the wheel hub portion.

5. The non-pneumatic tire according to claim 4 further comprising a brake rotor positioned on the inner side of the wheel hub portion, wherein the diamond-shaped flexible spokes is configured to pump air towards the brake rotor.

6. The non-pneumatic tire according to claim 3, wherein each of the plurality of diamond-shaped flexible spokes is configured as a bellows to force air from an inner side of the wheel hub portion to an outer side of the wheel hub portion.

7. The non-pneumatic tire according to claim 6 further comprising a brake rotor positioned on the inner side of the wheel hub portion, wherein the diamond-shaped flexible spokes is configured to pump air away from the brake rotor.

8. The non-pneumatic tire according to claim 3, wherein each of the plurality of diamond-shaped flexible spokes comprises a pair of inner legs and a pair of outer legs, and each of the plurality of hollow cores is defined by a pair of inner legs and a pair of outer legs.

9. The non-pneumatic tire according to claim 8, wherein each of the plurality of diamond-shaped flexible spokes comprises a pair of corners with one of the pair of inner legs intersecting one of the pair of outer legs at one of the pair of corners and another of the pair of inner legs intersecting another of the pair of outer legs at another of the pair of corners.

10. The non-pneumatic tire according to claim 9, wherein a distance between the pair of corners of each of the plurality of diamond-shaped flexible spokes increases from an outer side of the wheel hub portion to an inner side of the wheel hub portion.

11. The non-pneumatic tire according to claim 9, wherein a distance between the pair of corners of each of the plurality of diamond-shaped flexible spokes decreases from an outer side of the wheel hub portion to an inner side of the wheel hub portion.

12. A vehicle wheel assembly comprising:
a non-pneumatic tire comprising:
a wheel hub portion and a tread ring portion;
a plurality of flexible spokes extending between and coupled to the wheel hub portion and the tread ring portion;
a plurality of hollow cores defined between adjacent flexible spokes or within the plurality of flexible spokes; and
a brake rotor and a brake caliper, wherein the plurality of flexible spokes are configured to cyclically move between a narrow position and a wide position such that air is pumped from one side of the non-pneumatic tire to another side of the non-pneumatic tire when the vehicle wheel assembly is attached to a vehicle and is rolling on a road surface.

13. The vehicle wheel assembly according to claim 12, wherein each of the plurality of flexible spokes is configured as a bellows to force air from an outer side of the wheel hub portion to an inner side of the wheel hub portion.

14. The vehicle wheel assembly according to claim 12, wherein each of the plurality of flexible spokes is configured as a bellows to force air from an inner side of the wheel hub portion to an outer side of the wheel hub portion.

15. The vehicle wheel assembly according to claim 12, wherein a cross-sectional area of each of the plurality of hollow cores increases from an outer side of the wheel hub portion to an inner side of the wheel hub portion.

16. The vehicle wheel assembly according to claim 12, wherein a cross-sectional area of each of the plurality of hollow cores decreases from an outer side of the wheel hub portion to an inner side of the wheel hub portion.

17. A method of cooling a vehicle brake comprising:
rolling a vehicle wheel assembly along a road surface, the vehicle wheel assembly comprising a non-pneumatic and a brake, the non-pneumatic tire comprising:
a wheel hub portion and a tread ring portion;
a plurality of flexible spokes extending between and coupled to the wheel hub portion and the tread ring portion;
a plurality of hollow cores defined between adjacent flexible spokes or within the plurality of flexible spokes; and
cooling the brake by cyclically compressing and de-compressing the plurality of flexible spokes as the vehicle wheel assembly rolls along the road surface such that air is pumped from one side of the wheel hub portion to another side of the wheel hub portion.

18. The method according to claim 17, wherein cyclically compressing and de-compressing the plurality of flexible spokes pumps air from an outer side of the wheel hub portion to an inner side of the wheel hub portion such that the brake rotor is cooled.

19. The method according to claim 17, wherein cyclically compressing and de-compressing the plurality of flexible spokes pumps air from an inner side of the wheel hub portion to an outer side of the wheel hub portion such that the brake rotor is cooled.

20. The method according to claim 17, wherein a cross-sectional area of each of the plurality of hollow cores increases or decreases from an outer side of the wheel hub portion to an inner side of the wheel hub portion.
